(19) United States
(12) Patent Application Publication
(10) Pub. No.: US 2025/0371684 A1
(43) Pub. Date: Dec. 4, 2025

(54) MULTI-STAGE ENHANCEMENT FOR OBTAINING FINE-TUNED IMAGE

(71) Applicant: SAMSUNG ELECTRONICS CO., LTD., Suwon-si (KR)

(72) Inventors: Subhasmita SAHOO, Bengaluru (IN); Kinsuk DAS, Bengaluru (IN); Raj Narayana GADDE, Bengaluru (IN)

(73) Assignee: SAMSUNG ELECTRONICS CO., LTD., Suwon-si (KR)

(21) Appl. No.: 19/302,795

(22) Filed: Aug. 18, 2025

Related U.S. Application Data
(63) Continuation of application No. PCT/IB2024/053339, filed on Apr. 5, 2024.

(30) Foreign Application Priority Data
Apr. 7, 2023 (IN) 202341026244
Feb. 20, 2024 (IN) 202341026244

(51) Int. Cl. G06T 5/70; G06T 3/4053; G06T 5/50

(52) U.S. Cl. CPC G06T 5/70; G06T 3/4053; G06T 5/50; G06T 2207/20081

(57) ABSTRACT

Embodiments herein provide a method and an electronic device of multi-stage enhancement for obtaining a fine-tuned image. The method includes receiving, by an electronic device 201, an input image. The input image includes a noise element and an image feature to be enhanced. Further, the method includes decoding the input image to obtain a low-resolution image. Thereafter, the method generates a denoised image by removing the at least one noise element from the low-resolution image based on a noise reduction model.

### CROSS-REFERENCE TO RELATED APPLICATIONS

This application is a continuation of International Application No. PCT/IB2024/053339 designating the United States, filed on Apr. 5, 2024, in the Indian Patent Receiving Office and claiming priority to Indian Patent Application number 202341026244, filed on Apr. 7, 2023, and Indian Patent Application number 202341026244, filed on Feb. 20, 2024, the disclosures of each of which are incorporated by reference herein in their entireties.

### BACKGROUND

### 1. Field

Example embodiments of the disclosure relate to a field of image processing, and more particularly, to multi-stage enhancement for obtaining a fine-tuned image.

### 2. Description of Related Art

Over the years, significant advancements have been made in the realm of image processing. With the advent of technology, users are now able to capture high-quality images and videos using cameras. These captured images can be transmitted seamlessly between one or more electronic devices through wireless communication networks. Further, users can make video calls and zoom in and/or out on images or videos in real time on their mobile devices. Despite these advancements, real-time image and video enhancement remains a challenge.

In urban areas, video call quality is often hindered by low resolution due to network limitations. Furthermore, enhancing image details is needed for images and videos received from an external source, e.g., social networking sites, as well as for real-time zooming of images and videos in galleries. While related art noise reduction techniques can remove noise from images and videos, they often also remove important image details, leading to a loss of overall quality. Similarly, existing techniques for detail enhancement can increase noise in the image or video, thereby creating an unbalanced approach between noise reduction and detail enhancement.

An existing method employs a multi-frame strategy to enhance image resolution. This approach is utilized to upscale an uncompressed image for display on a high-resolution screen. The method places emphasis on reducing high-frequency noise and merging the noise-free and sharpened images. However, the method neglects to eliminate low-frequency noise and lacks the ability to regulate retention of detail and reduction of noise.

A related art method involves an image processing system that performs content adaptive image restoration scaling and enhancement for high-definition display. The system includes a texture estimator, a noise discriminator, a two-dimensional adaptive sharpener, a scaler, and an image enhancer. The texture estimator and the noise discriminator receive a low-resolution luminance component signal with an image block containing noise, generate a content adaptive kernel from the block, convolve the generated kernel with the signal, and produce a noise signal and an extracted texture without noise. The two-dimensional adaptive sharpener filters the luminance component signal with noise inhibition, generates an enhanced signal, and the scaler horizontally and vertically scales the enhanced signal and extracted texture, and adaptively scales the luminance component signal as a function of the scaled texture. The image enhancer combines the scaled components to generate an output signal with high resolution. However, this technique can only upscale an uncompressed image for display on a high-resolution screen, does not address compression artifacts, picks uncorrelated pixels as noise, and has no mention of real-time operation.

Another related art technique involves an adaptive image enhancement method. This method entails analyzing an input image to determine locations of human skin and further processing the image to improve areas of human skin on a per pixel basis. Further, the method measures blurriness levels in the input image and sharpens the image accordingly. Bright areas in the image are identified, and the sharpness is adjusted based on exposure levels of different areas of the image. It is important to note that this technique solely enhances the image and does not upscale the image. Furthermore, this method does not eliminate noise in the image and is only applicable to a still image.

One existing technique involves a method for restoring and reconstructing super-resolution images from low-resolution compressed images. This related art approach addresses an issue of optical limitations caused by a miniaturized camera in a digital video recorder monitoring system, which can result in a blurred video sequence. Further, the technique tackles spatial resolution limitations arising from insufficient pixel numbers in charge-coupled device (CCD) and/or Complementary Metal-Oxide Semiconductor (CMOS) image sensors, as well as noise generated during image compression, transmission, and storage processes. By restoring high-frequency components of low-resolution images, such as an appearance of a suspect's face or numbers on a license plate, a super-resolution image can be reconstructed. This allows for magnification of an area of interest in a low-resolution image to a high-resolution image, effectively simulating an effect of an expensive high-performance camera using a lower-end alternative. However, this related art technique relies on computationally expensive methods for noise reduction and enhancement, without a mechanism to balance between noise reduction and detail retention. Furthermore, this technique cannot be used for real-time applications due to its computationally intensive nature.

An existing method provides a system aimed at restoring details in image denoising. This system encompasses an initial denoising module and a detail recovery module. The former extracts image information that undergoes preliminary denoising from the image with noise. Meanwhile, the latter estimates the missing detail part and records the estimated detail information. However, the existing technique only enhances the image without performing upscaling. Further, the existing method fails to eliminate compression artifacts in the image and does not strike a balance between noise reduction and detail enhancement. Moreover, this method employs a generative model that may introduce undesired image features that are absent in an original image.

### SUMMARY

An object of one or more example embodiments is to provide a method and an electronic device of multi-stage enhancement for obtaining a fine-tuned image.

Another object of one or more example embodiments is to provide a multi-stage framework for noise reduction and texture enhancement of compressed image/video in real time.

Yet another object of one or more example embodiments is to provide a co-learning framework that trains two models designed for complementary tasks, namely, noise reduction and detail enhancement. Through co-learning, the co-learning framework ensures that image and video texture details are preserved while compression artifacts are selectively eliminated.

Another object of one or more example embodiments is to balance between noise reduction and detail reducing noise and retaining image or video details, based on a weighted combination of denoised and compressed images.

Another object of the embodiments herein is to maintain uphold the status PDU arrangement using segment offsets, without necessitating the upkeep of the count of lost SDUs.

Another object of the embodiments herein is to enhance the clarity of video calls even in unfavorable network conditions and minimize buffering time in high-resolution video streaming.

In one aspect, one or more objectives may be achieved by performing multi-stage enhancement for obtaining a fine-tuned image.

According to an aspect of an example embodiment, there is provided a method for controlling an electronic apparatus, the method including: receiving an input image, wherein the input image includes at least one noise element and at least one image feature; obtaining a low-resolution image by decoding the input image; generating a denoised image by removing the at least one noise element from the low-resolution image based on a noise reduction model; generating a composite image by combining the low-resolution image and the denoised image; obtaining a high-resolution composite image by scaling the composite image; and obtaining an output image by inputting the high-resolution composite image into a detail enhancement model to enhance the at least one image feature.

The at least one image feature may include at least one of a texture level, a sharpness level, a brightness level, an amount of content, a pixel intensity level, a depth level, or a resolution level of at least one portion of the input image.

The generating the denoised image may include inputting the low-resolution image to the noise reduction model to remove the at least one noise element from the low-resolution image; and obtaining the denoised image from the noise reduction model.

The noise reduction model may be trained by: inputting a high-resolution image to a downscaler to obtain a first low-resolution image; compressing the first low-resolution image to obtain a highly compressed image; decompressing the highly compressed image to obtain a decompressed low-resolution image; providing the decompressed low-resolution image to the noise reduction model; learning, by the noise reduction model, to denoise the decompressed low-resolution image; and outputting, by the noise reduction model, a denoised image, which is a noise reduced low-resolution image close to the first low-resolution image.

The generating the composite image may include: determining a detail retention weight for the low-resolution image based on a preset level of a texture detail to be retained; determining a noise reduction weight for the denoised image based on a preset level of noise reduction; and generating the composite image based on the noise reduction weight and the detail retention weight.

The obtaining the high-resolution composite image may include performing bilinear upscaling on the composite image to increase a height and a width of the composite image a factor.

The obtaining the output image may include: inputting the high-resolution composite image to the detail enhancement model; and performing detail enhancement of the high-resolution composite image using the detail enhancement model to obtain the output image.

The composite image may include at least some of features of the low-resolution image that are lost during denoising.

The detail enhancement model may include parameters tuned based on the decompressed low-resolution image, the denoised image, and input weights respectively denoting a desired level of noise reduction and a desired level of detail enhancement in the output image.

The detail enhancement model may be trained by: inputting a high-resolution image to a downscaler to obtain a first low-resolution image; compressing the first low-resolution image to obtain a highly compressed image; decompressing the highly compressed image to obtain a decompressed low-resolution image; providing the decompressed low-resolution image to the noise reduction model to obtain a noise reduced low-resolution image; performing bilinear upscaling on the noise reduced low-resolution image to obtain a noise reduced high-resolution image; and providing the noise reduced high-resolution image to the detail enhancement model to obtain a denoised and enhanced texture image.

According to an aspect of an example embodiment, there is provided an electronic device including: a processor configured to: receive an input image, wherein the input image includes at least one noise element and at least one image feature; obtain a low-resolution image by decoding the input image; generate a denoised image by removing the at least one noise element from the low-resolution image based on a noise reduction model; generate a composite image by combining the low-resolution image and the denoised image; obtain a high-resolution composite image by scaling the composite image; and obtain an output image by inputting the high-resolution composite image into a detail enhancement model to enhance the at least one image feature.

The at least one image feature may include at least one of a texture level, a sharpness level, a brightness level, an amount of content, a pixel intensity level, a depth level, or a resolution level of at least one portion of the input image.

The processor may be configured to: input the low-resolution image to the noise reduction model to remove the at least one noise element from the low-resolution image; and obtain the denoised image from the noise reduction model.

The noise reduction model may be trained by: inputting a high-resolution image to a downscaler to obtain a first low-resolution image; compressing the first low-resolution image to obtain a highly compressed image; decompressing the highly compressed image to obtain a decompressed low-resolution image; providing the decompressed low-resolution image to the noise reduction model; learning, by the noise reduction model, to denoise the decompressed low-resolution image; and outputting, by the noise reduction model, a denoised image, which is a noise reduced low-resolution image close to the first low-resolution image.

The processor may be further configured to: determine a detail retention weight for the low-resolution image based on a preset level of a texture detail to be retained; determine a noise reduction weight for the denoised image based on a preset level of noise reduction; and generate the composite image based on the noise reduction weight and the detail retention weight.

The processor may be configured to obtain the high-resolution composite image by performing bilinear upscaling on the composite image to increase a height and a width of the composite image a factor.

The processor may be configured to obtain the output image by: inputting the high-resolution composite image to the detail enhancement model; and performing detail enhancement of the high-resolution composite image using the detail enhancement model to obtain the output image. 18. The electronic device as claimed in claim 11, wherein the composite image comprises at least some of features of the low-resolution image that are lost during denoising.

The detail enhancement model may include parameters tuned based on the decompressed low-resolution image, the denoised image, and input weights respectively denoting a desired level of noise reduction and a desired level of detail enhancement in the output image.

The detail enhancement model may be trained by: inputting a high-resolution image to a downscaler to obtain a first low-resolution image; compressing the first low-resolution image to obtain a highly compressed image; decompressing the highly compressed image to obtain a decompressed low-resolution image; providing the decompressed low-resolution image to the noise reduction model to obtain a noise reduced low-resolution image; performing bilinear upscaling on the noise reduced low-resolution image to obtain a noise reduced high-resolution image; and providing the noise reduced high-resolution image to the detail enhancement model to obtain a denoised and enhanced texture image.

### BRIEF DESCRIPTION OF DRAWINGS

These and other features, aspects, and advantages of the disclosure are illustrated in the accompanying drawings, throughout which like reference letters indicate corresponding parts in the various figures. The embodiments herein will be better understood from the following description with reference to the drawings, in which:

FIG. 1A illustrates an image having compression anomalies;

FIG. 1B illustrates a scenario in which a phone is running out of memory and compressing images/videos for memory saving;

FIG. 1C illustrates a scenario where video quality deteriorates in a low network environment;

FIG. 1D illustrates a scenario of image and video zooming within a gallery;

FIG. 1E illustrates a scenario of recycling of an outdated mobile phone for purpose of home surveillance, facilitated by an Internet of Things (IoT) cloud interface application;

FIG. 2A is a block diagram that illustrates an electronic device with multi-stage enhancement for obtaining a fine-tuned image, according to an embodiment of the disclosure;

FIG. 2B is a block diagram that illustrates multi-stage enhancement framework for real-time image/video super resolution, according to an embodiment of the disclosure;

FIG. 2C is a block diagram that illustrates a co-learning of a noise reduction model and a detail enhancement model for obtaining a fine-tuned image, according to an embodiment of the disclosure;

FIG. 3A is a block diagram that illustrates a model architecture used for noise reduction and detail enhancement of an image and/or a video, according to an embodiment of the disclosure;

FIG. 3B is a block diagram that illustrates a co-learning pipeline between a noise reduction model and a detail enhancement model, according to an embodiment of the disclosure;

FIG. 3C is a block diagram that illustrates an inference pipeline of a noise reduction model and a detail enhancement model, according to an embodiment of the disclosure;

FIG. 4A is a block diagram that illustrates training of a noise reduction model, according to an embodiment of the disclosure;

FIG. 4B is a block diagram that illustrates training of a detail enhancement model, according to an embodiment of the disclosure;

FIG. 4C is a block diagram that illustrates learning of weights based on a trained noise reduction model and a trained detail enhancement model, according to an embodiment of the disclosure;

FIG. 4D is a block diagram that illustrates tuning of a detail enhancement model to compensate details lost by a noise reduction model, according to an embodiment of the disclosure;

FIG. 5 is a flow diagram that illustrates a method of multi-stage enhancement for obtaining a fine-tuned image, according to an embodiment of the disclosure;

FIG. 6A illustrates a scenario of comparison between an original image and a noise reduced image and enhanced image, according to an embodiment of the disclosure and a comparative example;

FIG. 6B illustrates a scenario of tuning noise reduction and texture retention in an image/video by a user, according to an embodiment of the disclosure;

FIG. 6C illustrates a scenario of enhancement of video quality in low network, according to an embodiment of the disclosure;

FIG. 6D illustrates a scenario of zooming of images/videos in gallery, according to an embodiment of the disclosure;

FIG. 6E illustrates a scenario of detail enhancement and noise reduction while restoring compressed image/videos stored in electronic device, according to an embodiment of the disclosure;

FIG. 6F illustrates a scenario of recycling a mobile device for home surveillance using an IoT cloud interface application, according to an embodiment of the disclosure.

FIG. 7 is a flow diagram that illustrates a method of multi-stage enhancement for obtaining a fine-tuned image, according to an embodiment of the disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the elements may have been represented in the drawing by related art symbols, and the drawings may show only those specific details that are pertinent to the understanding the embodiments of the disclosure so as not to obscure the drawing with details that will be readily apparent to those of ordinary skill in the art having benefit of the description herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments may be combined with one or more other embodiments to form new embodiments. The term “or” as used herein, refers to a non-exclusive or, unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

Embodiments are described and illustrated in terms of blocks that carry out a described function or functions. These blocks, which may be referred to herein as managers, units, modules, hardware components or the like, may be physically implemented by analog and/or digital circuits such as logic gates, integrated circuits, microprocessors, microcontrollers, memory circuits, passive electronic components, active electronic components, optical components, hardwired circuits and the like, and optionally may be driven by firmware and/or software. The circuits, for example, may be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it is understood that the embodiments presented herein are not limited by the accompanying drawings. As such, the disclosure is construed to extend to any alterations, equivalents and substitutes in addition to those which are particularly set out in the accompanying drawings. Although the terms first, second, etc. used herein to describe various elements, these elements should not be limited by these terms. These terms are generally used to distinguish one element from another.

Accordingly, the embodiments provide a method of multi-stage enhancement for obtaining a fine-tuned image. The method may include receiving, by an electronic device, an input image. The input image comprises at least one noise element and at least one image feature to be enhanced. Further, the method may include decoding the input image to obtain a low-resolution image. Thereafter, the method may include generating a denoised image by removing the at least one noise element from the low-resolution image based on a noise reduction model. Furthermore, the method may include determining a composite image by combining the low-resolution image and the denoised image. Also, the method may include scaling the composite image to obtain a high-resolution composite image. Furthermore, the method may include determining, by the electronic device, an output image by inputting the high-resolution composite image into a detail enhancement model to enhance the at least one image feature, wherein the output image is free from or has reduction in the at least noise element, and wherein the output image comprises the at least one enhanced image feature.

The embodiments may minimize noise and amplify details in low-resolution images, while simultaneously reducing compression noise. The embodiments may use two complementary models for noise reduction and image enhancement, trained via a co-learning framework. The embodiments need less computation, which is viable for real-time implementation. The two complementary models may learn from each other's limitations, resulting in an improved on-device tool for single image super resolution and compression noise reduction. Furthermore, the disclosure provides a device-independent approach, which allows for seamless downloading and usage across various devices.

Accordingly, the embodiments provide an electronic device of multi-stage enhancement for obtaining a fine-tuned image. The electronic device may comprise a processor and an image feature controller. The image feature controller may be configured to receive an input image. The input image may comprise at least one noise element and at least one image feature to be enhanced. Further, the image feature controller may decode the input image to obtain a low-resolution image. Also, the image feature controller generates a denoised image by removing the at least one noise element from the low-resolution image based on a noise reduction model. Further, the image feature controller determines a composite image by combining the low-resolution image and the denoised image. Also, the image feature controller scales the composite image to obtain a high-resolution composite image. Furthermore, the image feature controller determines an output image by inputting the high-resolution composite image into a detail enhancement model to enhance the at least one image feature. The output image may be free from the at least noise element, and the output image may comprise the at least one enhanced image feature.

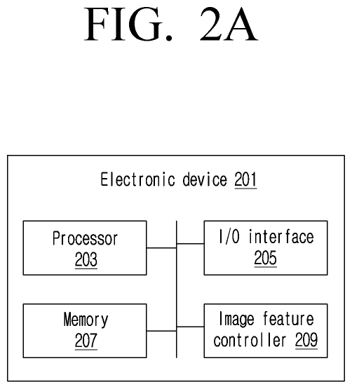

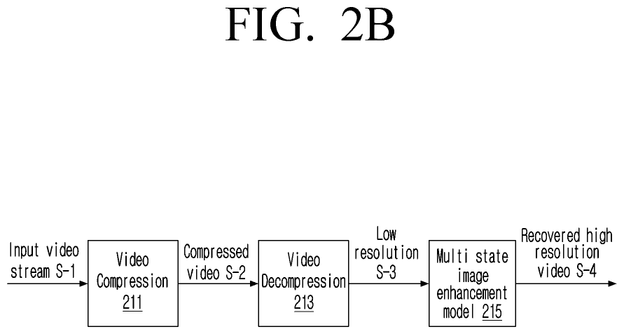

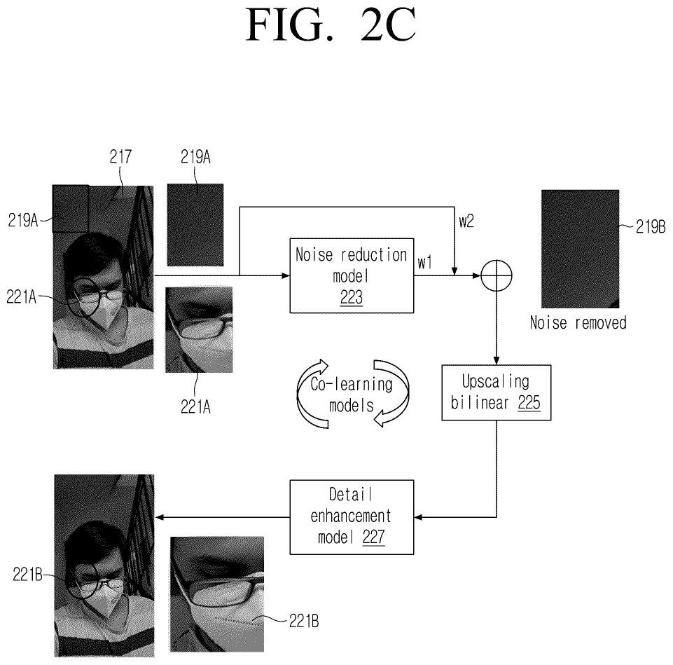

The embodiments may employ a co-learning framework to train two complementary models: a noise reduction model and a detail enhancement model. The noise reduction model effectively may reduce noise in an image or video, while a weighted combination of the decoded and denoised images is used to recover lost details. Further, the detail enhancement model may enhance an overall quality of the image or video. The noise reduction and detail enhancement models may be trained separately, and a weighted combination w1, w2 (see FIG. 2C) of the models may be learned after fixing them. Further, the detail enhancement model may be fine-tuned after fixing both models. This co-learning model may effectively restore texture details that may have been lost during a noise removal process.

The embodiments may mitigate noise and augment details in low-resolution images. The embodiments may effectively reduce compression noise while simultaneously enhancing image details. The embodiments may employ two complementary models for noise reduction and image enhancement, and utilize a co-learning framework to train these models for their respective tasks. Moreover, the embodiments may need minimal computation, making real-time implementation feasible. The two complementing models may learn from each other's limitations, thereby providing an improved on-device tool for single image super resolution and compression noise reduction. Further, the embodiments provide a device-independent approach that may be easily downloaded and utilized on any device.

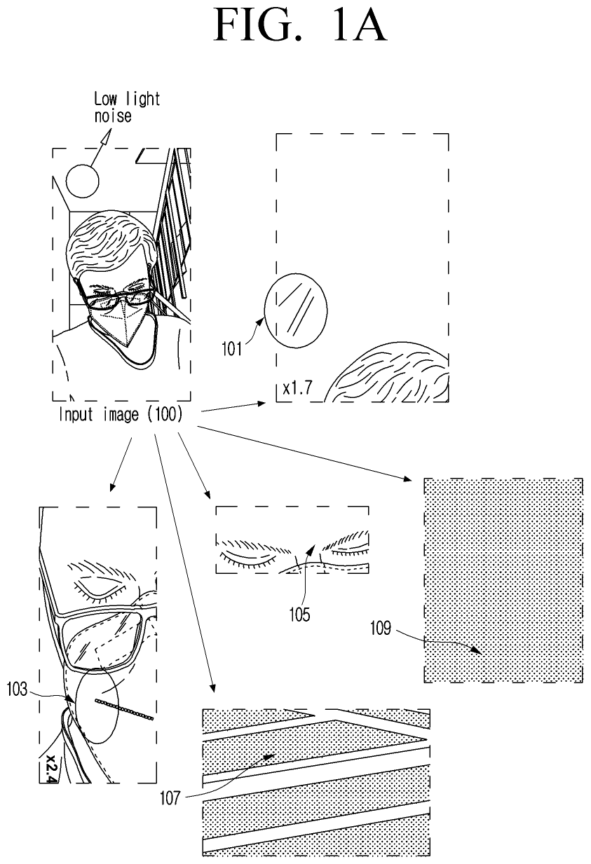

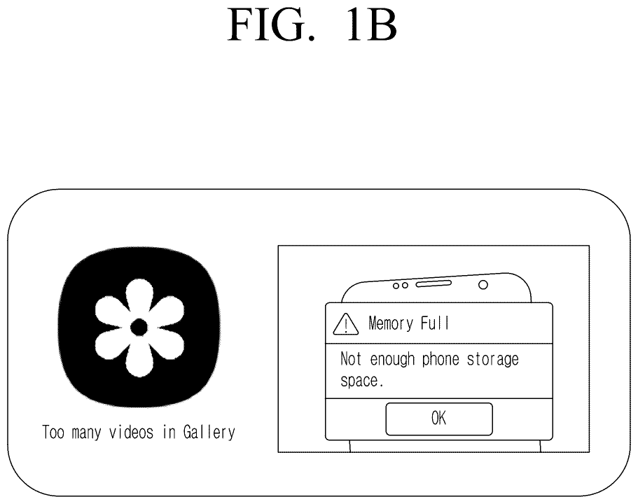

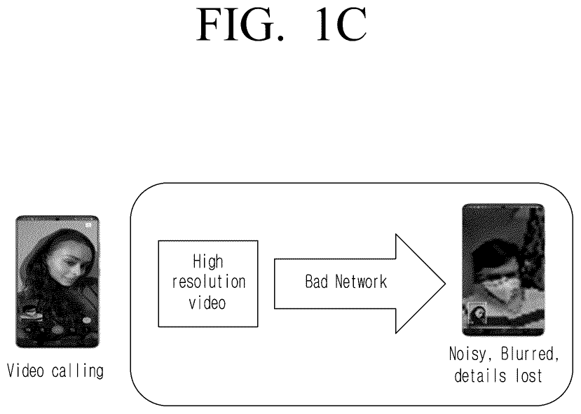

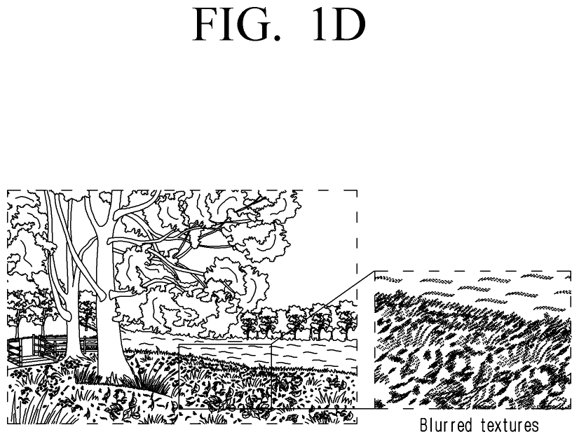

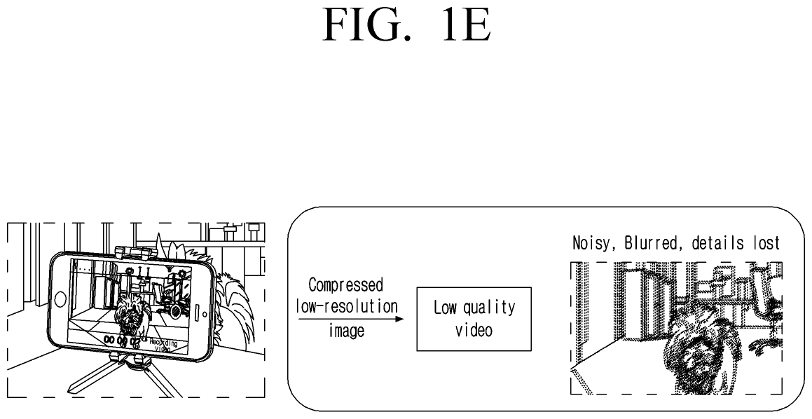

FIG. 1A illustrates an example of an image having compression anomalies. An electronic device may capture an image 100 which may then be stored in the electronic device. In one embodiment, the image 100 may be a frame from a video. However, the image 100 may contain compression anomalies, such as marks 101 visible on a clean wall, blurred stitch marks 103, lines 105 on a forehead that resemble wrinkles, noise 107 near dark edges, and salt and pepper noise 109 in low light regions. These compression artifacts are a result of the high quantization of the image/video and may be further exacerbated by the high frequency noise that is captured when taking images/videos in low light conditions.

FIG. 1B illustrates a scenario of a phone running out of memory and compressing images/videos for memory saving. There may be a situation where a phone or an electronic device has a shortage of memory. In such cases, images and videos may be compressed and stored to accommodate a limited memory space. However, when a user desires to access these stored images or videos, a decompression process is initiated. During this decompression process, certain details of the images or videos may be lost.

FIG. 1C illustrates a scenario of degradation of video quality in low network. In this scenario, in an event of a user initiating a video call from a network with a limited bandwidth, video frames may be streamed at a reduced resolution. Further, noise present in low-light areas cannot be effectively eliminated at a call receiving end, resulting in a potentially noisy, blurry video with a possibility of losing certain details.

FIG. 1D illustrates a scenario of zooming of images/videos in gallery. In this scenario, users are able to zoom in on images and videos in real time. However, it is important to note that as the user zooms in, certain key details may become obscured or lost entirely. Further, this process may lead to an increase in image noise, resulting in a blurry or unclear picture.

FIG. 1E illustrates a scenario of recycling a mobile device (e.g., smartphone) for home surveillance using an Internet of Things (IoT) cloud interface application. In an event that a user seeks to reuse a mobile phone for home surveillance via certain mobile applications, a particular issue may arise during the recycling process. Specifically, compressed, low-resolution images or videos may experience an increase in compression noise while undergoing detail enhancement. This may lead to the undesirable outcome of producing images or videos that are both blurry and lacking in detail.

FIG. 2A is a block diagram that illustrates an electronic device of multi-stage enhancement for obtaining a fine-tuned image, according to an embodiment of the disclosure. An electronic device 201 may include a processor 203, an input/output (I/O) interface 205, a memory 207 and an image feature controller 209. The electronic device 201 may be at least one of a mobile phone, tablet, a computer, a laptop, and a smart watch, for example, but is not limited thereto. Further, the processor 203 of the electronic device 201 may communicate with the memory 207, the I/O interface 205 and the image feature controller 209. The processor 203 may be configured to execute instructions stored in the memory 207 and to perform various processes. The processor 203 may include one or a plurality of processors, and may be a general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU), but is not limited thereto.

Further, the memory 207 of the electronic device 201 may include storage locations to be addressable through the processor 203. The memory 207 is not limited to a volatile memory and/or a non-volatile memory. Further, the memory 207 may include one or more computer-readable storage media. The memory 207 may include non-volatile storage elements. For example, non-volatile storage elements may include magnetic hard discs, optical discs, floppy discs, flash memories, or forms of electrically programmable memories (EPROM) or electrically erasable and programmable (EEPROM) memories. The memory 207 may store the media streams such as audios stream, video streams, haptic feedbacks and the like. The memory 207 may store some of the images/videos captured by the electronic device and/or received from another electronic device through a communication network. Also, the memory 207 may store compressed images/videos and/or decompressed images/videos. Further, the memory 207 may store a denoised images/videos, a composite images/videos obtained by combining low-resolution image and denoised image, and a detail enhanced images/videos with noise reduced.

The I/O interface 205 may transmit information between the memory 207 and one or more external peripheral devices. The peripheral devices may include input-output devices associated with the electronic device 201. The I/O interface 205 may receive a plurality of images and/or videos from one or more mobile devices or electronic devices over a wireless communication network.

The image feature controller 209 may be a cutting-edge hardware component that involves physical implementation of both analog and digital circuits, encompassing logic gates, integrated circuits, microprocessors, microcontrollers, memory circuits, passive and active electronic components, as well as optical components. The role of the image feature controller 209 may communicate with the I/O interface 205 and the memory 207 of the electronic device 201 to obtain a finely-tuned image through multi-stage enhancement.

The electronic device 201 may receive an input image, which comprises at least one noise element and at least one image feature to be enhanced. This input image may be received from another electronic device over a wireless communication network or stored in the memory 207 of the electronic device 201. The input image may also be a high-resolution image or a frame of a video.

The image feature controller 209 may decode the input image to obtain a low-resolution image, and compress the high-resolution image in the process. The image feature controller 209 may then generate a denoised image by removing a noise element from the low-resolution image based on a noise reduction model that uses a noise reduction technique.

The image feature controller 209 may determine a composite image by combining the low-resolution image and the denoised image in a weighted manner that boosts lost details in the images and/or videos that were lost during the denoising process. The derived composite image may be a low-resolution image, which is then scaled to obtain a high-resolution composite image. This process may include converting the low-resolution composite image to the high-resolution image.

The image feature controller 209 may determine the output image by inputting the composite image into a detail enhancement model that enhances at least one image feature of the composite image. A final output image may be free from noise element and comprise at least one enhanced image feature, such as a texture level, a sharpness level, a brightness level, an amount of content, a pixel intensity level, a depth level, and a resolution level of the input image.

The noise reduction and detail enhancement models may be trained independently, with a weighted combination of w1 and w2 learned after both models are fixed. Further, the detail enhancement model may be fine-tuned with pre-determined values of w1 and w2 for the noise reduction model. This collaborative learning approach between the two models may result in images and/or videos having improved quality with reduced noise and enhanced details.

In FIG. 2B, a multi-stage enhancement framework for real-time image/video super resolution according to an embodiment of the disclosure is depicted. At S-1, a low-resolution video may be fed into a video compression block 211. This input video may be provided from a storage of the electronic device 201, which is previously captured by a camera of the electronic device 201, or received via a wireless communication network. The video compression block 211 may compress a low-resolution video stream, creating a compressed low-resolution video. The compressed low-resolution video may then be inputted to a video decompression block 213 at S-2. The video decompression block 213 may decompress the low-resolution video, which may include compression noise. At S-3, a decompressed noisy low-resolution video may be fed into a multi-stage enhancement model 215, which removes noise and enhances image features. The multi-stage enhancement model 215 may include a noise reduction model that removes noise from the video, to generate a denoised video. However, the noise reduction model may determine some faint objects in the video as noise and remove these objects. Thus, a composite image may be generated by combining the denoised image and the decompressed noisy low-resolution video, bringing back faint edges of objects lost during denoising. The composite image may then be inputted to the detail enhancement model, which enhances the details of the video, such as a sharpness, a brightness, a clarity, and/or the like. Ultimately, at S-4, the multi-stage enhancement model 215 may provide a noiseless and enhanced high-resolution video.

FIG. 2C depicts a block diagram illustrating co-learning of a noise reduction model and a detail enhancement model, to produce a finely tuned image. Consider an image 217 that is fed into a multi-stage enhancement model 215. The input image 217A may contain a blurred region 221A and a low light region 219A, and is low-resolution. The multi-stage enhancement model 215 may enhance the input image 217 at multiple stages, including two sub-models, namely a noise reduction model 223 and a detail enhancement model 227.

The noise reduction model 223 may reduce noise in the input image 217 using an AI model. The denoised image shows a reduction of noise in the low light region 219A. After noise reduction, a composite image may be determined to compensate for the loss of details. The composite image may be obtained by combining the denoised image and the input image 217, with a weighted combination performed based on a weight w1 and a weight w2 to balance between noise reduction and detail enhancement. The weights w1, w2 may be received from the user or pre-configured (or preset) based on applications used by the users in the electronic device 201.

The composite image may then be upscaled using bilinear upscaling 225 to obtain a high-resolution composite image, based on weights w1 and w2. The high-resolution composite image may then be inputted to the detail enhancement model 227, which learns from the losses of the noise reduction model 223 and enhance at least one image feature, such as a texture level, a sharpness level, a brightness level, an amount of content of at least one portion of the input image, a pixel intensity level, a depth level, and a resolution level. For instance, the detail enhancement model 227 may remove blurriness in the input image 217 to generate an output image including a clear and sharp region 221B, corresponding to the blurred region 221A of the input image 217, including a noise-free (or noise reduced) region 219B. This co-learning process between the noise reduction model 223 and the detail enhancement model 227 is referred to as co-learning.

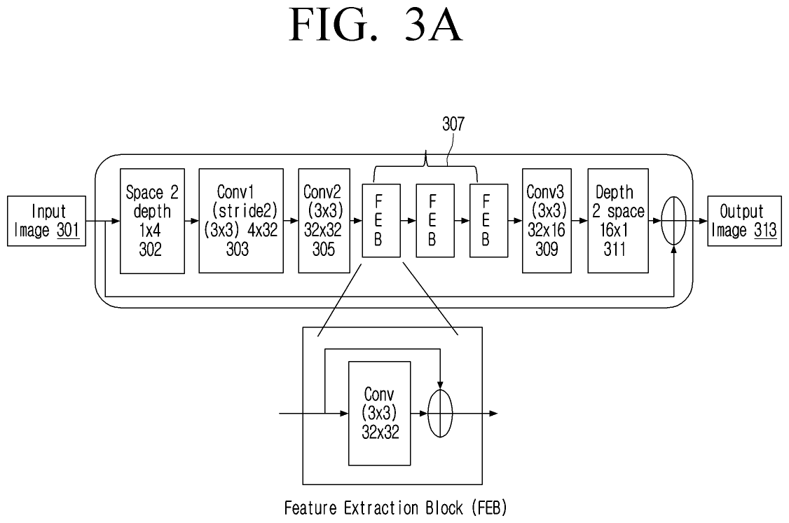

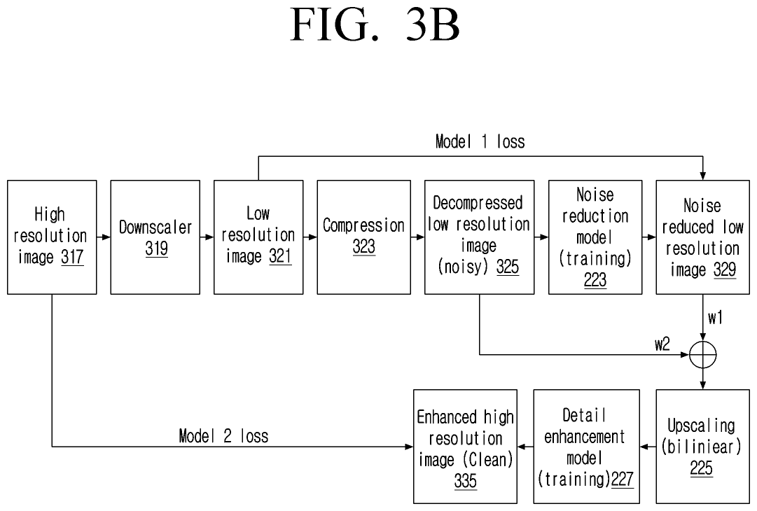

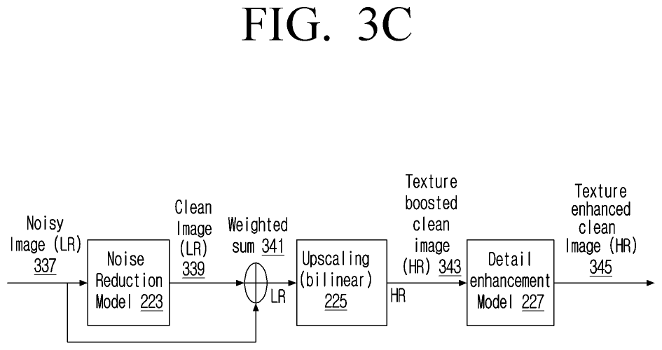

FIG. 3A is a block diagram that illustrates a model architecture used for noise reduction and detail enhancement of an image/video, according to an embodiment of the disclosure. A convolutional neural network (CNN) model architecture depicted in FIG. 3A may be used for training both the noise reduction model 223 and the detail enhancement model 227. An input image 301 may be fed into the CNN model, which then learns one or more features of the image through a series of layers 302, 303, 305, 309, 311 including convolutional layers, Rectified Linear Unit (ReLU) layers, and pooling layers. A feature extraction block 307 may extract desired features from the input image 301 during the learning process. Ultimately, the CNN model may produce an output image 313 that has been refined and enhanced through the extraction of the features.

FIG. 3B is a block diagram that illustrates a co-learning pipeline between the noise reduction model and detail enhancement model, according to an embodiment of the disclosure. In FIG. 3B, a co-learning process between the noise reduction model 223 and the detail enhancement model 227 is illustrated. Initially, a high-resolution image 317 may be fed into the multi-stage enhancement model 215. The high-resolution input image 317 may then be passed on to a downscaler 319, which downscales the image 317 to a low-resolution image 321. The low-resolution image 321 may be further compressed at 323 and decompressed, which may introduce noisy features into a decompressed low-resolution image 325.

The noise reduction model 223 may be trained to learn image features of the image 325 input thereto. During training, the noise reduction model 223 may determine noise in the decompressed low-resolution image 325 and remove the noise, and generate a noise-reduced low-resolution image 329. The image 329 may then be combined with the decompressed low-resolution image 325 based on the weights w1 and w2 received from the user. The weight w1 may represent a desired amount of noise in the output image and the weight w2 may represent a desired level of detail. The resulting composite image may be subjected to bilinear upscaling 225 to be converted to a high-resolution composite image.

The high-resolution composite image may then be inputted to the detail enhancement model 227, which may be trained using a CNN technique. Based on the training, the detail enhancement model 227 may enhance image features in the high-resolution composite image, resulting in an enhanced high-resolution image 335. The detail enhancement model 227 may also be tuned to compensate for any details lost by the noise reduction model 223, which may be determined by comparing the input high-resolution image 317 and the enhanced high-resolution image 335.

FIG. 3C is a block diagram that illustrates an inference pipeline of the noise reduction model and the detail enhancement model, according to an embodiment of the disclosure. In a realm of image and video capture, low-resolution images and videos (referred to as “image” hereinafter) are often captured at Quarter video graphics Array (qVGA) (320×240) resolution or ninth High Definition (nHD) (640×360) resolution. The captures images may then be compressed to reduce memory consumption and stored in electronic devices with limited storage capacity or sent over networks with a low bandwidth. While users may zoom in on certain portions of the compressed image to see more details, this often results in a blurred image. To restore an original image, the compressed image may be first decompressed, and a low-resolution image or video 337 (corresponding to the zoomed portion) may be extracted. The low-resolution image or video 337 may then be passed through a multi-stage detail enhancement model to restore a denoised, high-resolution image or video. Further, the low-resolution image may be subjected to a noise-reduction model 223 to reduce noise in the image or video. A resulting noise-reduced image 339 may be combined with an original noisy image or video 337 using a weighted combination 341 to create a composite image with reduced noise and enhanced details. The composite image may then be upscaled to a high resolution using a bilinear upscaler 225, and passed through the detail enhancement model 227 to produce a final image 345 with reduced noise and enhanced details, or output as a texture-boosted image 343.

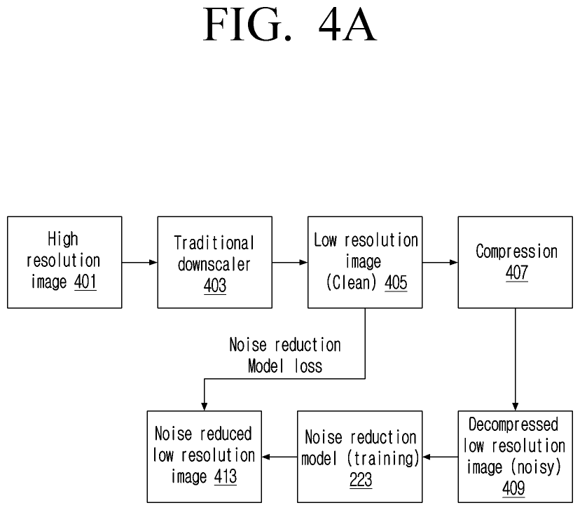

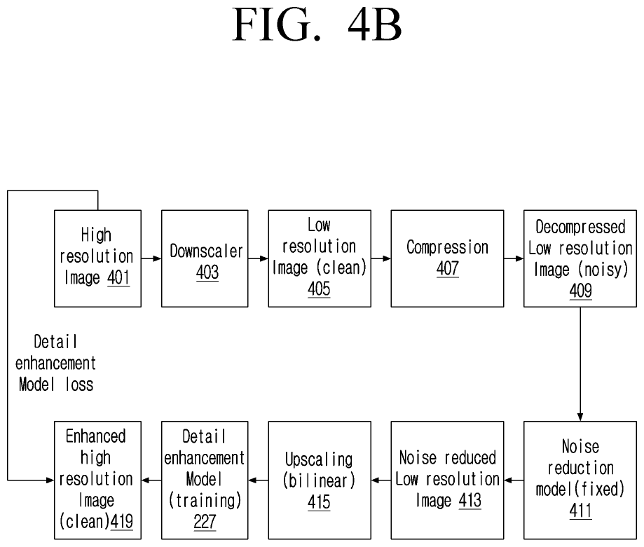

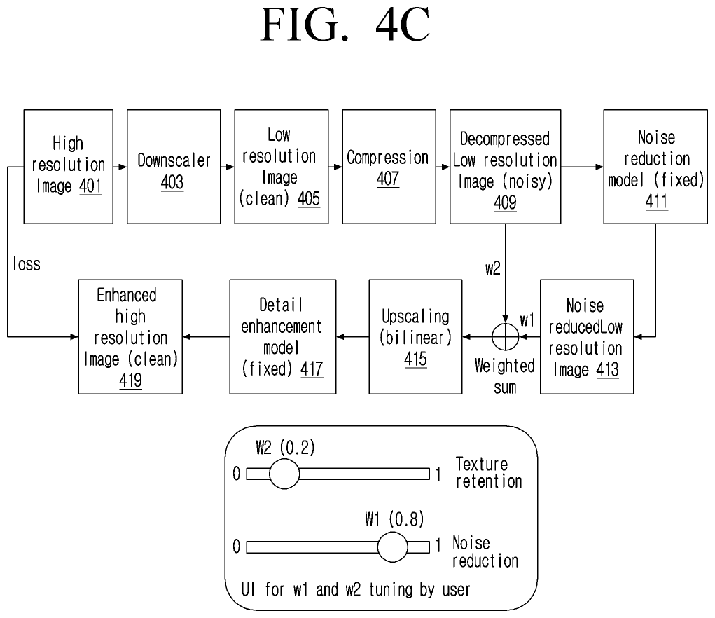

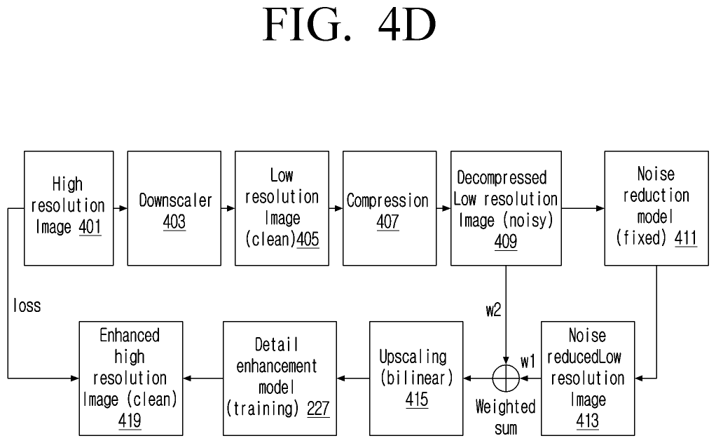

FIG. 4A is a block diagram that illustrates training of a noise reduction model, according to an embodiment of the disclosure. During the training process, a training dataset may include high-resolution images (e.g., 1280×720, HD) 401. The high-resolution images may then be downscaled to a lower resolution (e.g., 640×360, nHD) 405 using a downscaler 403. Further, compression may be applied to the low-resolution image 405, which is then decompressed to obtain a decompressed low-resolution image 409. Noise may be introduced during the compression and decompression process, resulting in a noisy 640×360 image 409.

The aforementioned decompressed low-resolution image 409 may then be fed into the noise reduction model 223 that has been trained inputted decompressed low-resolution images 409. Upon completion of the training process, the noise reduction model 223 may output a noiseless (or noise-reduced) 640×360 image 413. Further, a backpropagation is performed to update the noise reduction weight w1 based on the noise reduction loss.

FIG. 4B is a block diagram that illustrates training of a detail enhancement model, according to an embodiment of the disclosure. In the process of training, the dataset may include high-resolution images (e.g., 1280×720, HD) 401. These images may be downscaled to low-resolution images (e.g., 640×360, nHD) 405 through the use of a downscaler 403. Following this, compression 407 may be applied to the low-resolution images 405, which are then decompressed to produce a decompressed low-resolution image 409. However, this process may introduce noise into the image (noisy 640×360) 409. To counteract this, the decompressed low-resolution image 409 may be fed into a noise reduction model 411, which generates a noise-reduced low-resolution image 413. The noise-reduced image 413 may then be upscaled to high-resolution using bilinear upscaling 415. The detail enhancement model 227 is further trained using the noise-reduced high-resolution images, and produces an enhanced high-resolution image 419. During training of the detail enhancement model 227, the noise reduction model 411 remains fixed. Once training is complete, a backpropagation may be performed to update the detail enhancement weight w2 based on the detail enhancement loss.

FIG. 4C is a block diagram that illustrates learning of weights w1 and w2 based on a trained noise reduction model and a trained detail enhancement model, according to an embodiment of the disclosure. Acquisition of w1 and w2 is based on trained models 411, 417 for noise reduction and detail enhancement. Initially, the user may input values for w1 and w2 through the electronic device 201 via a user interface. w1 indicates the desired level of noise reduction in the output, while w2 indicates the desired level of detail enhancement. For instance, the user may set w1 to 0.8 and w2 to 0.2. During the learning process, the noise reduction and detail enhancement models 411, 417 remain fixed, and the optimal values for w1 and w2 may be determined based on a desired degree of noise reduction and texture detail preservation (or texture retention) in an output image. Furthermore, w1 and w2 may be adjusted to ensure that their sum equals one. This balance between noise reduction and texture detail retention may be maintained by decreasing one value while increasing the other. For example, if w1 is high, and w2 is low, the output image may have excellent noise reduction but may lose some detail. Conversely, if w1 is low, and w2 is high, the output image will retain large texture details but may still have some noise. Further, a loss between a high-resolution ground truth and the enhanced high-resolution image may be calculated. Backpropagation of this loss may be used to adjust w1 and w2, ensuring that the noise reduction process minimizes a texture loss. Depending on application requirements, w1 and w2 may be further fine-tuned using the user interface to retain the desired texture information. If all texture information is required, but some noise may be tolerated, w2 may be increased, and w1 may be decreased. Similarly, if noise needs to be removed as much as possible, but some texture loss may be tolerated, w1 may be increased, and w2 may be decreased.

FIG. 4D is a block diagram that illustrates tuning of a detail enhancement model to compensate details lost by a noise reduction model, according to an embodiment of the disclosure. The initial high-resolution image 401 may be downscaled to a low-resolution image (640×360, nHD) 405 using a downscaler 403. Further, compression 407 may be applied to the low-resolution image 405. The compressed low-resolution image is then decompressed to obtain a decompressed low-resolution image 409, which may suffer from noise incurred during compression and decompression. The decompressed low-resolution image 409 may then be fed into the noise reduction model 411, which generates a noise-reduced low-resolution image 413. A weighted combination of the noise-reduced low-resolution image 413 and the decompressed low-resolution image 409 may be performed to recover the lost details of the decompressed low-resolution image 409 during denoising. The resulting composite image may then be passed through an upscaler to obtain a high-resolution image (e.g., 1280×720) using bilinear upscaling 415. The high-resolution composite image may further be processed by the detail enhancement model 227, which is trained using a plurality of noise-reduced high-resolution images. During training, the noise reduction model 411 may be fixed, and the detail enhancement model 227 may output an enhanced high-resolution image 419. Upon completion of training, a backpropagation may be performed to update the detail enhancement weight w2 based on the detail enhancement loss. The weight w2 of the detail enhancement model 227 may be adjusted to compensate for the loss incurred by the noise reduction model 411 while enhancing the texture details.

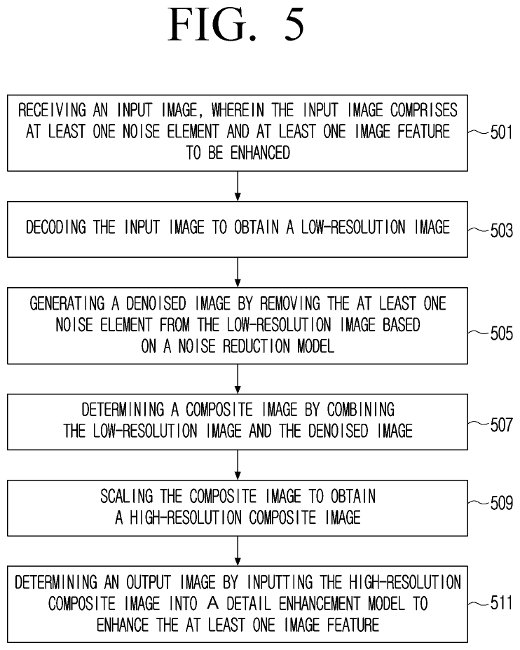

FIG. 5 is a flow diagram that illustrates a method of multi-stage enhancement for obtaining a fine-tuned image, according to an embodiment of the disclosure.

At 501, the image feature controller 209 of the electronic device 201 may receive an input image. This input image may contain a noise element and at least one image feature that requires enhancing. The input image may be sourced from various origins, including but not limited to being stored within the memory 207 of the electronic device 201, captured by the camera of the electronic device 201, or received from another device via a wireless communication network.

At 503, the image feature controller 209 may decode the input image into a low-resolution format. This decoding process may include decompression of the input image to produce a low-resolution image. However, such decompression may introduce some level of noise into the resulting low-resolution image.

At 505, the image feature controller 209 may produce a refined image by eliminating one or more noise elements from the low-resolution image via the noise reduction model 223. This process may employ various noise reduction techniques. Further, the I/O interface 205 may provide the weights w1 and w2, where w1 determines the level of noise desired in the output image, and w2 determines the degree of texture detail desired in the output image.

At 507, the image feature controller 209 may generate a composite image by merging or combining the low-resolution image with the denoised image. This process is based on a weighted combination using values of w1 and w2, which aids in retrieval of any lost details in the denoised image.

At 509, the image feature controller 209 may resize the composite image to produce a high-resolution composite image. At 511, the image feature controller 209 may employ the detail enhancement model 227 to derive an output image from the high-resolution composite image. Through the detail enhancement model 227, the at least one image features in the high-resolution composite image may be enhanced, resulting in a denoised and detail-enhanced image as the output image.

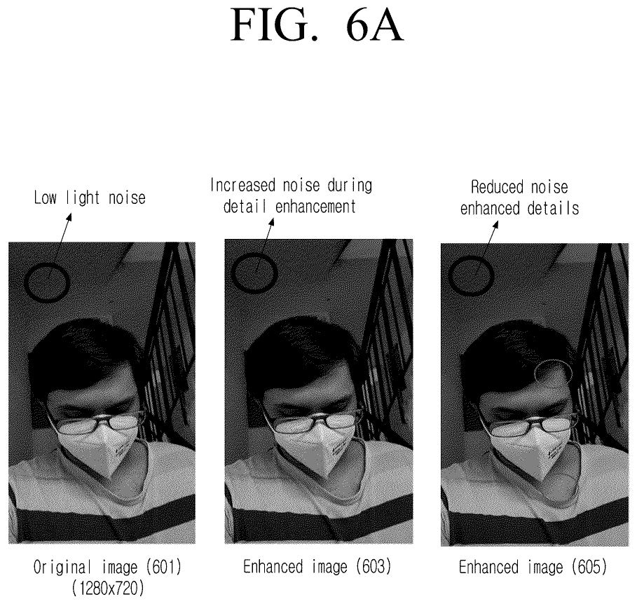

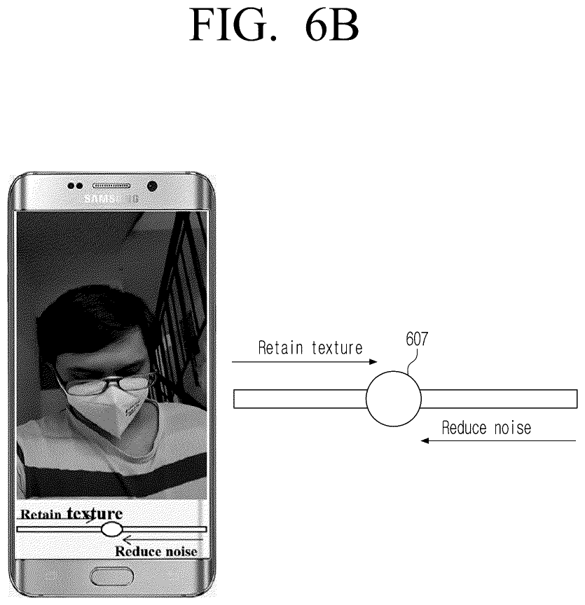

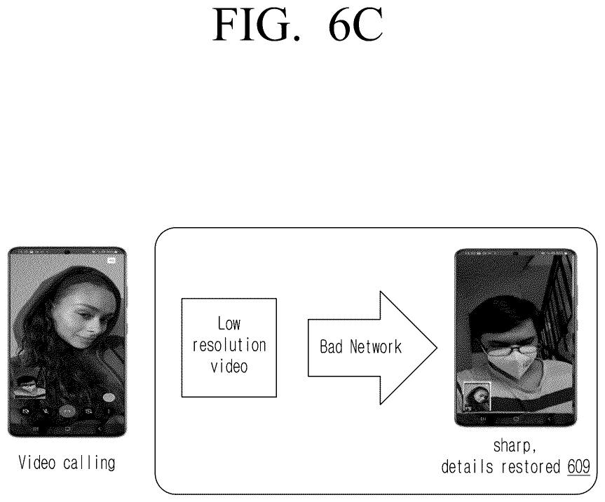

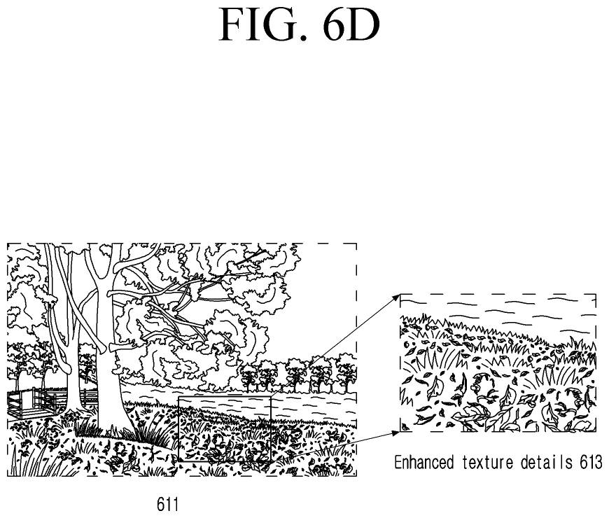

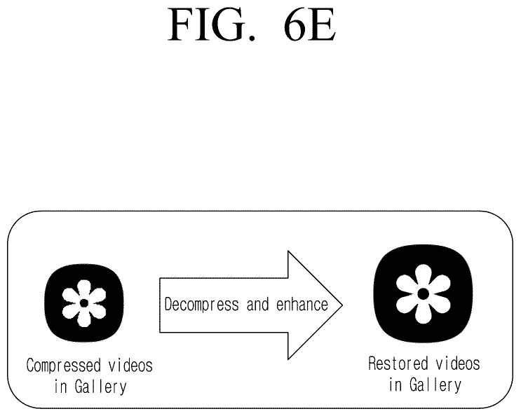

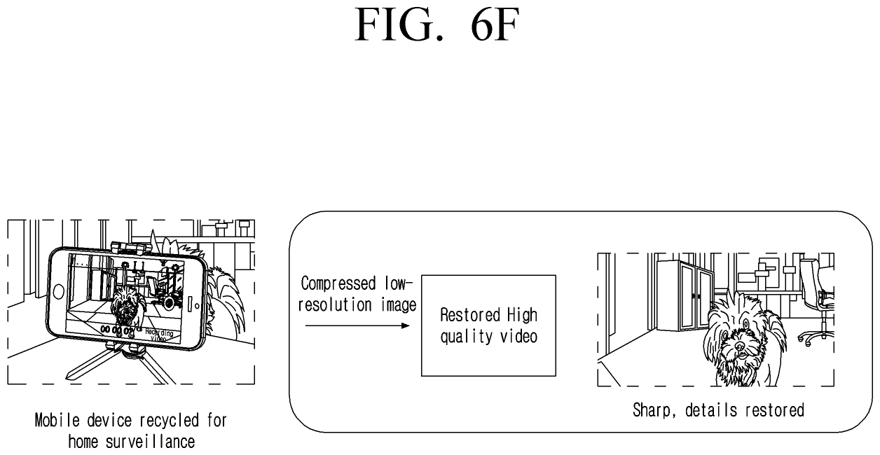

FIG. 6A illustrates a scenario of comparison between an original image and a noise reduced image and enhanced image, according to an embodiment of the disclosure and a comparative example. An image 601 represents an original image that may be captured by the electronic device 201 or stored in the memory 207 of the electronic device 201. An image 603 represents a detail enhanced image generated according to a comparative example (e.g., using existing technique). The image 603 may include increased noise in the image during detail enhancement. An image 605 represents a detail enhanced image that is generated by the multi-stage framework model according to an embodiment of the disclosure. The image 605 generated by the multi-stage framework model may be both noise reduced and detail enhanced.

FIG. 6B illustrates a scenario of tuning noise reduction and texture retention in an image/video by a user, according to an embodiment of the disclosure. As depicted in FIG. 6B, the user may specify an extent of noise and texture details to be preserved in the resulting image. In an embodiment, this may be done via a slider 607 on the user interface, which allows the user to adjust the desired values of w1 and w2, but the embodiment is not limited thereto. W1 denotes a desired level of noise in the output image, while w2 indicates a desired level of texture details. Moreover, the image feature controller 209 of the electronic device 201 may enhance and retain textural elements in highly textured images or videos. On the other hand, the image feature controller 209 may eliminate noise in images or videos with smoother regions and less texture.

FIG. 6C illustrates a scenario of enhancement of video quality in low network, according to an embodiment of the disclosure. In an example scenario, a user may be engaged in a video call while operating in a low network environment. In such a scenario, the texture details of the video call require real-time enhancement while simultaneously reducing noise. To accomplish this, the image feature controller 209 may eliminate low light noise and upscale the image. Moreover, the image feature controller 209 may enhance the texture details with minimal noise, as demonstrated in an image 609 at the receiver's end.

FIG. 6D illustrates a scenario of zooming of images/videos in gallery, according to an embodiment of the disclosure. In an example scenario, a user may zoom in on an image 611 stored in the memory 207 of the electronic device 201. As the user zooms, the feature controller 209 of the electronic device 201 may seamlessly provide a highly detailed and noise-free zoomed portion of the image, as shown in an image 613.

FIG. 6E illustrates a scenario of detail enhancement and noise reduction while restoring compressed image/videos stored in electronic device, according to an embodiment of the disclosure. In a case where a memory space of the electronic device 201 is insufficient, it may be necessary to compress certain images and videos for storage in the memory 207. During this compression process, the image feature controller 209 may execute a multi-stage image correction to refine and enrich the compressed image or video. Further, the image feature controller 209 may minimize any noise that may arise during the enhancement of image or video details.

FIG. 6F illustrates a scenario of recycling a mobile device (e.g., smartphone) for home surveillance using an IoT cloud interface application, according to an embodiment of the disclosure. When recycling a mobile device for home surveillance, images and videos obtained through surveillance function of the mobile device tend to occupy a substantial amount of a memory space. To address this issue, the image feature controller 209 may minimize compression noise and augment image details. Consequently, the compressed images may be stored in the electronic device 201 without compromising their quality.

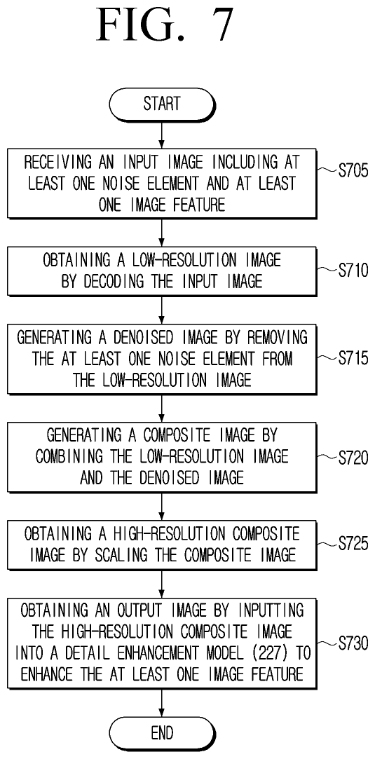

FIG. 7 is a flow diagram that illustrates a method of multi-stage enhancement for obtaining a fine-tuned image, according to an embodiment of the disclosure.

Referring to FIG. 7, a method for controlling an electronic apparatus may include receiving an input image, wherein the input image includes at least one noise element and at least one image feature (S705).

The at least one noise element may be described as noise information, noise feature, noise area, first information, first feature or first area.

The at least one image feature may be described as at least one feature element.

The at least one image feature may be described as feature information, non-noise feature, feature area, second information, second feature or second area. The area may be described as region. The at least one image feature may be described as Rol (Region of Interest) information.

The input image may include at least one of noise element or image feature.

The method may include obtaining a low-resolution image by decoding the input image (S710).

The input image may be described as first resolution image, normal quality image, first size image.

The low-resolution image may be described as second resolution image, low quality image, second size image.

The decoding may be described as down-scaling. The method may include obtaining (or generating) the low-resolution image by down-scaling the input image from the first resolution to the second resolution based on a first scaling ratio.

The scaling ratio may be described as scaling ratio information or scaling parameter. The first resolution may be greater than the second resolution.

The second resolution may be a pre-determined resolution. The second resolution may be changed according to a user input.

The method may include generating (or obtaining) a denoised image by removing the at least one noise element from the low-resolution image based on a noise reduction model 223 (S715).

The denoised image may be described as filtered image, changed image or noise free image.

The noise reduction model 223 may be described as the noise removing model or the noise eliminating model.

The method may include identifying the at least one noise element based on the input image. The method may include identifying the first area corresponding to the at least one noise element among the input image. The method may include removing the at least one noise element based on the first area from the low-resolution image.

The method may include identifying a first sub area corresponding the first area based on the first scaling ratio. The method may include removing the at least one noise element based on the sub first area from the low-resolution image.

The method may include generating (or obtaining) a composite image by combining the low-resolution image and the denoised image (S720).

The composite image may be described as merged image, complexed image, combination image, complete image or synthetic image. The generating the composite image may include overlapping the low-resolution image to (or into) the denoised image (S720).

The method may include obtaining a high-resolution composite image by scaling the composite image (S725).

A resolution of the composite image may be the second resolution.

The high-resolution composite image may be described as high-resolution image, third resolution image, high quality image, third size image.

The scaling may be described as up-scaling or encoding. The method may include obtaining (or generating) the high-resolution composite image by up-scaling the composite image from the second resolution to the third resolution based on a second scaling ratio.

The scaling ratio may be described as scaling ratio information or scaling parameter. The third resolution may be greater than the second resolution.

In one embodiment, the third resolution may be same with the first resolution.

In another embodiment, the third resolution may be greater than the first resolution.

The third resolution may be a pre-determined resolution. The third resolution may be changed according to a user input.

The method may include obtaining an output image by inputting the high-resolution composite image into a detail enhancement model 227 to enhance the at least one image feature (S730).

The detail enhancement model 227 may be described as enhancement model or improvement model.

The method may include obtaining the output image by enhancing the at least one image feature in the input image based on the high-resolution composite image.

The method may include identifying the at least one image feature based on the input image. The method may include identifying the second area corresponding to the at least one image feature among the input image. The method may include enhancing the at least one image feature based on the second area from the high-resolution composite image.

The method may include identifying a second sub area corresponding the second area based on the second scaling ratio. The method may include enhancing the at least one image feature based on the sub second area from the high-resolution composite image.

The output image may be free from or has reduction in the at least noise element. The output image may include the at least one enhanced image feature.

The output image may include the at least one enhanced image feature without the at least noise element.

The at least one image feature may include at least one of a texture level of the input image, a sharpness level of at least one portion of the input image, a brightness level of at least one portion of the input image, amount of content of at least one portion of the input image, a pixel intensity level of at least one portion of the input image, a depth level of at least one portion of the input image, or a resolution level of the at least one portion of the input image.

The generating the denoised image may include inputting the low-resolution image to the noise reduction model 223 to remove the at least one noise element from the low-resolution image and obtaining the denoised image from the noise reduction model.

The noise reduction model may be trained by a plurality of operations. The plurality of operations may include inputting a high-resolution image to a downscaler to obtain the low-resolution image, compressing the low-resolution image to obtain a highly compressed image, decompressing the highly compressed image to obtain a decompressed low-resolution image, providing the decompressed low-resolution image to the noise reduction model, learning, by the noise reduction model, to denoise the decompressed low-resolution image and outputting, by the noise reduction model, the denoised image.

The denoised image may be a noise reduced low-resolution image close to the original low-resolution image.

The downscaler may be described as down scaling model.

The generating the composite image may include determining a detail retention weight w1 for the low-resolution image based on user selection (or pre-configuration) of an extent of texture detail to be retained, determining a noise reduction weight w2 for the denoised image, wherein the reduction weight w2 indicates a level of noise reduction based on user selection (or pre-configuration), and generating the composite image based on the noise reduction weight for the denoised image and the detail retention weight for the low-resolution image. For example, the reduction weight w2 may be determined such that the extent of texture detail selected by the user (or pre-configured) may be achieved.

The obtaining a high-resolution composite image may include performing bilinear upscaling to increase the resolution of the composite image where a height and a width of the composite image is increased by a required factor.

The obtaining the output image may include inputting the high-resolution composite image to the detail enhancement model and performing detail enhancement of the high-resolution composite image using the detail enhancement model to obtain the output image.

The composite image may include at least some of features of the low-resolution image that are lost during denoising.

The detail enhancement model may include parameters tuned based on the decompressed low-resolution image, denoised image and input weights w1, w2.

The detail enhancement model may be trained by a plurality of operations. The plurality of operations may include inputting a high-resolution image to a downscaler to obtain the low-resolution image, compressing the low-resolution image to obtain a highly compressed image, decompressing the highly compressed image to obtain a decompressed low-resolution image, providing the decompressed low-resolution image to the noise reduction model to obtain a noise reduced low-resolution image, performing bilinear upscaling to obtain a noise reduced high-resolution image, and providing noise reduced high-resolution image to the detail enhancement model to obtain a denoised and enhanced texture image.

The embodiments provide a multi-stage framework for real-time noise reduction and texture enhancement of compressed images and videos. Further, the embodiments provide a method for co-learning two distinct models—one for noise reduction and the other for detail enhancement—to compensate for each other's deficiencies. The disclosure may enhance images in two distinct stages: first, by reducing noise, and then by enhancing details. To achieve this, a weighted combination of the input image and the noise-reduced image is utilized to preserve lost details, while simultaneously enhancing image textures. The disclosure may be particularly effective in addressing compression artifacts commonly found in low-light images and videos, which become more visible when zooming. By leveraging a novel co-learning framework to train models for two complementary tasks, the disclosure may enhance textural details in images while removing compression artifacts, thereby producing high-quality, noise-suppressed images and videos. The disclosure promises to enhance the user experience by improving the quality of images and videos, ensuring good video call quality even in low-network scenarios, providing improved real-time zoom quality on mobile phones, compressing long videos without losing details, enhancing the quality of images and videos downloaded from social networking sites, and furnishing noise-free, high-quality video. Further, the disclosure offers a new lease of life to old phones by repurposing them as surveillance cameras.

A novel approach to real-time noise reduction and texture enhancement of compressed images/videos is presented through a multi-stage framework. Conventional image enhancement methods fall short when dealing with compressed media due to the presence of artefacts, or texture-like noise. Attempting to reduce noise often results in lost details, while enhancing details may also amplify noise. To address this issue, two separate models are co-learned for these complementary tasks. One model compensates for the other's shortcomings, resulting in a two-step process of noise reduction followed by detail enhancement. A weighted combination of the input image and the noise-reduced image is used to retain lost details, while the textures are enhanced in the next step.

The embodiments may prevent compression artefacts that are prevalent in low-light images/videos and become highly visible when zoomed. These artefacts resemble image textures, making it difficult to remove them while retaining texture details. The co-learning framework according to the embodiments may train models for both complementary tasks, resulting in the enhancement of textural details while removing compression artefacts. The embodiments may provide high-quality, noise-free (or noise-reduced) images/videos, improving user experience in various applications such as video calls, real-time zooming on mobile devices, compressing long videos without losing details, enhancing the quality of images/videos downloaded from social networking sites, and providing high-quality video when using a phone as a surveillance camera.

Existing techniques typically focus on either noise or details, often compromising one for the other. Further, most existing techniques only claim to reduce high-frequency noise, whereas the disclosure not only removes high-frequency noise but also compression artefacts that resemble image texture. Overall, the multi-stage framework according to the embodiments of the disclosure provide improved and effective noise reduction and texture enhancement in compressed images/videos.

At least one of the components, elements, modules or units (collectively “components” in this paragraph) represented by a block in the drawings, may be embodied as various numbers of hardware, software and/or firmware structures that execute respective functions described above, according to one or more example embodiments. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method for controlling an electronic apparatus, the method comprising:
receiving an input image, wherein the input image includes at least one noise element and at least one image feature;
obtaining a low-resolution image by decoding the input image;
generating a denoised image by removing the at least one noise element from the low-resolution image based on a noise reduction model;
generating a composite image by combining the low-resolution image and the denoised image;
obtaining a high-resolution composite image by scaling the composite image; and
obtaining an output image by inputting the high-resolution composite image into a detail enhancement model to enhance the at least one image feature.

2. The method as claimed in claim 1, wherein the at least one image feature includes at least one of a texture level, a sharpness level, a brightness level, an amount of content, a pixel intensity level, a depth level, and a resolution level of at least one portion of the input image.

3. The method as claimed in claim 1, wherein the generating the denoised image comprises:
inputting the low-resolution image to the noise reduction model to remove the at least one noise element from the low-resolution image; and
obtaining the denoised image from the noise reduction model.

4. The method as claimed in claim 1, wherein the noise reduction model is trained by:
inputting a high-resolution image to a downscaler to obtain a first low-resolution image;
compressing the first low-resolution image to obtain a highly compressed image;
decompressing the highly compressed image to obtain a decompressed low-resolution image;
providing the decompressed low-resolution image to the noise reduction model;
learning, by the noise reduction model, to denoise the decompressed low-resolution image; and
outputting, by the noise reduction model, a denoised image, which is a noise reduced low-resolution image close to the first low-resolution image.

5. The method as claimed in claim 1, wherein the generating the composite image comprises:
determining a detail retention weight for the low-resolution image based on a preset level of a texture detail to be retained;
determining a noise reduction weight for the denoised image based on a preset level of noise reduction; and
generating the composite image based on the noise reduction weight and the detail retention weight.

6. The method as claimed in claim 1, wherein the obtaining the high-resolution composite image comprises:
performing bilinear upscaling on the composite image to increase a height and a width of the composite image a factor.

7. The method as claimed in claim 1, wherein the obtaining the output image comprises:
inputting the high-resolution composite image to the detail enhancement model; and
performing detail enhancement of the high-resolution composite image using the detail enhancement model to obtain the output image.

8. The method as claimed in claim 1, wherein the composite image comprises at least some of features of the low-resolution image that are lost during denoising.

9. The method as claimed in claim 4, wherein the detail enhancement model includes parameters tuned based on the decompressed low-resolution image, the denoised image, and input weights respectively denoting a desired level of noise reduction and a desired level of detail enhancement in the output image.

10. The method as claimed in claim 1, wherein the detail enhancement model is trained by:
inputting a high-resolution image to a downscaler to obtain a first low-resolution image;
compressing the first low-resolution image to obtain a highly compressed image;
decompressing the highly compressed image to obtain a decompressed low-resolution image;
providing the decompressed low-resolution image to the noise reduction model to obtain a noise reduced low-resolution image;
performing bilinear upscaling on the noise reduced low-resolution image to obtain a noise reduced high-resolution image; and
providing the noise reduced high-resolution image to the detail enhancement model to obtain a denoised and enhanced texture image.

11. An electronic device comprising:
a processor configured to:
receive an input image, wherein the input image includes at least one noise element and at least one image feature;
obtain a low-resolution image by decoding the input image;
generate a denoised image by removing the at least one noise element from the low-resolution image based on a noise reduction model;
generate a composite image by combining the low-resolution image and the denoised image;
obtain a high-resolution composite image by scaling the composite image; and
obtain an output image by inputting the high-resolution composite image into a detail enhancement model to enhance the at least one image feature.

12. The electronic device as claimed in claim 11, wherein the at least one image feature includes at least one of a texture level, a sharpness level, a brightness level, an amount of content, a pixel intensity level, a depth level, or a resolution level of at least one portion of the input image.

13. The electronic device as claimed in claim 11, wherein the processor is configured to:
input the low-resolution image to the noise reduction model to remove the at least one noise element from the low-resolution image; and
obtain the denoised image from the noise reduction model.

14. The electronic device as claimed in claim 11, wherein the noise reduction model is trained by:
inputting a high-resolution image to a downscaler to obtain a first low-resolution image;
compressing the first low-resolution image to obtain a highly compressed image;
decompressing the highly compressed image to obtain a decompressed low-resolution image;
providing the decompressed low-resolution image to the noise reduction model;
learning, by the noise reduction model, to denoise the decompressed low-resolution image; and
outputting, by the noise reduction model, a denoised image, which is a noise reduced low-resolution image close to the first low-resolution image.

15. The electronic device as claimed in claim 11, wherein the processor is further configured to:
determine a detail retention weight for the low-resolution image based on a preset level of a texture detail to be retained;
determine a noise reduction weight for the denoised image based on a preset level of noise reduction; and
generate the composite image based on the noise reduction weight and the detail retention weight.

16. The electronic device as claimed in claim 11, wherein the processor is configured to obtain the high-resolution composite image by:
performing bilinear upscaling on the composite image to increase a height and a width of the composite image a factor.

17. The electronic device as claimed in claim 11, wherein the processor is configured to obtain the output image by:
inputting the high-resolution composite image to the detail enhancement model; and
performing detail enhancement of the high-resolution composite image using the detail enhancement model to obtain the output image.

18. The electronic device as claimed in claim 11, wherein the composite image comprises at least some of features of the low-resolution image that are lost during denoising.

19. The electronic device as claimed in claim 14, wherein the detail enhancement model includes parameters tuned based on the decompressed low-resolution image, the denoised image, and input weights respectively denoting a desired level of noise reduction and a desired level of detail enhancement in the output image.

20. The electronic device as claimed in claim 11, wherein the detail enhancement model is trained by:
inputting a high-resolution image to a downscaler to obtain a first low-resolution image;
compressing the first low-resolution image to obtain a highly compressed image;
decompressing the highly compressed image to obtain a decompressed low-resolution image;
providing the decompressed low-resolution image to the noise reduction model to obtain a noise reduced low-resolution image;
performing bilinear upscaling on the noise reduced low-resolution image to obtain a noise reduced high-resolution image; and
providing the noise reduced high-resolution image to the detail enhancement model to obtain a denoised and enhanced texture image.
